(19) United States
(12) Patent Application Publication
(10) Pub. No.: US 2020/0236980 A1
(43) Pub. Date: Jul. 30, 2020

(54) High-content Buckwheat Dried Noodles and Processing Method Thereof

(71) Applicant: Jiangnan University, Wuxi (CN)

(72) Inventors: Kexue Zhu, Wuxi (CN); Dapeng Tong, Wuxi (CN); Yali Wang, Wuxi (CN); Ruiheng Ji, Wuxi (CN)

(21) Appl. No.: 16/850,551

(22) Filed: Apr. 16, 2020

Related U.S. Application Data
(63) Continuation of application No. PCT/CN2019/081001, filed on Apr. 2, 2019.

(30) Foreign Application Priority Data
May 28, 2018 (CN) 2018105224308

(51) Int. Cl. A23L 7/109; A23L 7/104; A23L 7/10; A21D 13/047; A21D 2/18; A21D 2/26; A21D 2/34; A21D 2/36; A23L 3/358; A23L 3/01; A23L 3/005; A21C 11/10; A21C 3/02

(52) U.S. Cl. CPC A23L 7/109; A01M 17/008; A23L 7/115; A21D 13/047; A21D 2/186; A21D 2/265; A21D 2/34; A21D 2/366; A23L 3/358; A23L 3/01; A23L 3/005; A23L 7/198; A21C 11/10; A21C 3/02; A23V 2002/00; A23L 7/107

(57) ABSTRACT

The present disclosure discloses a high-content buckwheat dried noodle and a preparation method thereof, and belongs to the field of multi-grain flour products processing. The high-content buckwheat dried noodle of the present disclosure includes whole buckwheat flour, high-gluten wheat flour, vital wheat gluten, resistant starch, egg white powder, sodium alginate, konjac flour, sodium carbonate, glutamine aminotransferase, hemicellulase and phytase. The preparation method include: preprocessing a buckwheat raw material, optimizing a ratio of raw materials to auxiliary materials, and vacuum mixing, improved sheeting process, cutting, hanging, drying, strip shortening, packaging and other techniques and preparing high-content buckwheat dried noodles. By using the enzyme modification technique, the present disclosure improves protein cross-linking, increases soluble dietary fiber content, and biodegrades the anti-nutritional factor phytic acid, thereby effectively improving the utilization rate of nutrients, controlling the generation of post-prandial blood glucose and preventing obesity. Moreover, the high-content buckwheat dried noodle of the present disclosure includes no edible salt in its formula, is a healthy low-salt product which conforms to the concept of modern healthy diet.

### TECHNICAL FIELD

The present disclosure relates to high-content buckwheat dried noodles and processing method thereof, and belongs to the fields of multigrain noodle products processing field.

### BACKGROUND

Buckwheat is rich in nutrition. Buckwheat generally has higher content of protein, fat, vitamin, and mineral than staple grains such as rice, wheat (flour), and corn. It features low thermal energy, high unsaturated fatty acid content, reasonable amino acid composition, and high protein biological value, and is known as one of the most popular healthy foods in this new century. Grains are prone to be damaged by pests during storage, and this is also the case for buckwheat. Also, buckwheat has a high content of fat, which, together with the effects of enzymes and microorganisms, makes buckwheat susceptible to rancidity, leading to the problem of short shelf life. Therefore, pretreatment of buckwheat is necessary before it is processed into finished products.

Dried noodles have a long history in China and are one of the main food products of the Asian people. The dried noodles with excellent quality have gluten protein that has properties such as high viscosity and springiness that some grains do not have. Buckwheat does not contain gluten protein. Therefore, the addition of high-content buckwheat flour in dried noodles can easily cause technical problems such as unable to be sheeted, sticking to rollers, and high breaking rate in the production process of dried buckwheat noodles.

### SUMMARY

The main objective of the present disclosure is to provide a high-content buckwheat dried noodle and a method for making the same to overcome the shortcomings of the prior art.

In order to achieve the foregoing objective, the technical solutions adopted by the present invention include:

The present disclosure provides a dried buckwheat noodle, which comprises ingredients in parts by weight represented by a following formula: 60-90 parts of whole buckwheat flour, 15-30 parts of high-gluten wheat flour, 5-15 parts of vital wheat gluten, 1-15 parts of resistant starch, 0.5-3 parts of egg white powder, 0.01-0.5 parts of sodium alginate, 0.01-0.15 parts of konjac flour, 0.01-0.15 parts of sodium carbonate, 5-60 U/g glutamine aminotransferase, 50-400 U/g hemicellulase, and 50-400 U/g phytase.

Further, the whole buckwheat flour accounts for 80-90% of the total weight of the high-gluten wheat flour and the whole buckwheat flour in the dried buckwheat noodle.

Further, the formula of the dried buckwheat noodle comprises 80 parts of whole buckwheat flour, 15 parts of high-gluten wheat flour, 10 parts of vital wheat gluten, 5 parts of resistant starch, 1.5 parts of egg white powder, 0.2 parts of sodium alginate, 0.1 parts of konjac flour, 25 U/g glutamine aminotransferase, 120 U/g hemicellulase, and 200 U/g phytase.

The present disclosure further provides a method of preparing dried high-content buckwheat noodle, which comprises the steps of:

(1) preparing raw materials according to the composition of the aforesaid high-content buckwheat dried noodle;

(2) well mixing whole buckwheat flour, high-gluten wheat flour, vital wheat gluten, resistant starch, egg white powder, sodium alginate, konjac flour, glutamine transaminase, hemicellulase and phytase, and then adding the resultant mixture into a vacuum mixer to obtain a mixed powder;

(3) well mixing the mixed powder with an aqueous solution of sodium carbonate in the vacuum mixer, and starting the vacuum mixer for dough mixing to obtain crumbly dough;

(4) leaving the crumbly dough obtained in the step (3) to rest at room temperature;

(5) sheeting the crumbly dough obtained in the step (4) to obtain a dough sheet;

(6) cutting the dough sheet obtained in the step (5) to obtain long strips, hanging them on noodle rods, and drying to obtain long strips of buckwheat dried noodles;

(7) cutting the long strips of buckwheat dried noodles obtained in the step (6) to obtain short strips, and weighing and packaging them to obtain the high-content buckwheat dried noodles.

As one of the preferred solutions, the step (1) comprises: providing buckwheat grains, subjecting the buckwheat grains to disinfestation and sterilization treatment, and then pulverizing them to obtain whole buckwheat flour.

Further, the disinfestation and sterilization treatments comprise: washing and tempering the buckwheat grains with ozone water or slightly acidic electrolyzed water to reach a final moisture of 13.0-16.0 wt %, and then treating them with superheated steam, radio frequency heating or microwave.

Further, the disinfestation and sterilization treatments comprise washing and tempering with slightly acidic electrolyzed water in combination with radio frequency heating.

Further, the slightly acidic electrolyzed water has a concentration of available chlorine of 30-70 ppm and a pH value of 5.8-6.2.

Further, the radio frequency heating treatment is controlled to have a resonant frequency of 20-45 MHz, power of 5-20 kW and distance between the polar plates of 40-120 mm, the thickness of the buckwheat grains on the conveyor belt is 20-50 mm, the treatment time is 180-600 s, and the temperature at which the buckwheat grains discharged from the radio-frequency cavity is 50-90° C. The conveyor belt is reciprocated to carry out radio frequency insecticidal treatment.

Further, the step (1) comprises: grinding the buckwheat grains obtained after the disinfestation and sterilization treatment, and then subjecting them to ultrafine pulverization or low-temperature vortex pulverization to obtain whole buckwheat flour; or alternatively, grinding the buckwheat grains obtained after the disinfestation and sterilization treatment using a roller flour mill to obtain buckwheat core powder and buckwheat bran powder, subjecting the buckwheat bran powder to ultrafine pulverization or low-temperature vortex pulverization, and then mixing the resultant buckwheat bran powder with the buckwheat core powder to obtain whole buckwheat flour.

Further, the drying is performed by a five-stage drying method, which specifically comprises: (1) shaping with cold air at a temperature of 25-30° C. and a relative humidity of 85-90%; (2) low-speed dehydration at a temperature of 39-45° C. and a relative humidity of 78-85%; (3) high-speed dehydration at a temperature of 42-46° C. and a relative humidity of 70-76%; (4) cooling down to temper at a temperature of 34-36° C. and a relative humidity of 56-60%; (5) extended tempering at room temperature for a period of time.

Compared with the prior art, the beneficial effects of the present disclosure are:

(1) The disclosure adopts slightly acidic electrolyzed water combined with radio frequency heating technology to treat buckwheat grains, which can completely kill Insects, Insect eggs and bacteria without affecting the quality of buckwheat flour, thereby achieving the purpose of extending the shelf life of the product;

(2) According to the disclosure, the buckwheat bran particles are pulverized by low-temperature vortex pulverization, so that the dietary fiber, flavonoids and slow-digesting starch in buckwheat are completely retained, which can effectively control the post-prandial blood glucose of diabetic patients, conforms to the current natural and healthy nutrition trend, and satisfies the needs on staple food of special populations such as patients with diabetes, obesity, and three highs;

(3) By using the enzyme modification technique, the present disclosure improves protein cross-linking, increases soluble dietary fiber content, and biodegrades the anti-nutritional factor phytic acid, thereby effectively improving the utilization rate of nutrients, controlling the generation of post-prandial blood glucose and preventing obesity.

(4) The dried high-content buckwheat noodle of the present disclosure comprises no edible salt in its formula, is a healthy low-salt product which conforms to the concept of modern healthy diet;

(5) The present disclosure optimizes the quality of dried buckwheat noodles by pre-processing buckwheat raw materials, optimizing the ratio of raw and auxiliary materials, adding auxiliary materials such as vital wheat gluten, and using techniques including vacuum dough kneading and improved rolling process. Also, the present disclosure finally solves bottlenecks that dried buckwheat noodles are difficult to process, easily break, and have bad taste, making the preparation of dried high-content buckwheat noodles possible. At the same time, the dried noodles of the present disclosure are rich in nutrients, simple in process, and convenient to cook.

(6) On the basis of ordinary dried noodles, the present disclosure finds out the optimal ratio of raw and auxiliary materials such as whole buckwheat flour (80%), high-gluten wheat flour, vital wheat gluten, konjac flour, sodium carbonate and other ingredients through scientific research, thereby developing high-quality dried buckwheat noodles. Whole buckwheat flour is used in the formula, which retains the nutritional components of the grains (dietary fiber, flavonoids, etc.) to the greatest extent, removes most of phytic acid and phytate, degrades cellulose, and increases the dietary fiber content, and has the effect of controlling the generation of postprandial blood glucose. Therefore, it is the staple food of choice for people with diabetes, obesity, and three highs.

### DETAILED DESCRIPTION

In view of the shortcomings in the prior art, the inventor of the present disclosure was able to propose the technical solution of the present disclosure through long-term research and extensive practice. The technical solution, its implementation process and principle will be further explained as follows.

The present disclosure provides a buckwheat dried noodle, which comprises ingredients in parts by weight represented by a following formula: 60-90 parts of whole buckwheat flour, 15-30 parts of high-gluten wheat flour, 5-15 parts of vital wheat gluten, 1-15 parts of resistant starch, 0.5-3 parts of egg white powder, 0.01-0.5 parts of sodium alginate, 0.01-0.15 parts of konjac flour, 0.01-0.15 parts of sodium carbonate, 5-60 U/g glutamine aminotransferase, 50-400 U/g hemicellulase, and 50-400 U/g phytase.

Further, the high-content buckwheat dried noodle comprises water, the water accounting for 25-32% of the total weight of the aforesaid raw materials.

The high-content buckwheat dried noodles of the present disclosure use buckwheat flour as a main raw material, and incorporate vital wheat gluten and high-gluten wheat flour to increase the viscoelasticity of dried noodles.

On the basis of ordinary dried noodles, the present disclosure finds out the optimal ratio of raw and auxiliary materials such as whole buckwheat flour (80%), high-gluten wheat flour, vital wheat gluten, konjac flour, sodium carbonate and other ingredients through scientific research, thereby developing high-quality buckwheat dried noodles. Whole buckwheat flour is used in the formula, which retains the nutritional components of the grains (dietary fiber, flavonoids, etc.) to the greatest extent, removes most of phytic acid and phytate, degrades cellulose, and increases the dietary fiber content, and has the effect of controlling the generation of postprandial blood glucose. Therefore, it is the staple food of choice for people with diabetes, obesity, and three highs.

The present disclosure further provides a method of preparing high-content buckwheat dried noodle, which comprises the steps of:

(1) preparing raw materials according to the composition of the aforesaid high-content buckwheat dried noodle;

(2) well mixing whole buckwheat flour, high-gluten wheat flour, vital wheat gluten, resistant starch, egg white powder, sodium alginate, konjac flour, glutamine transaminase, hemicellulase and phytase, and then adding the resultant mixture into a vacuum mixer to obtain a mixed powder;

(3) well mixing the mixed powder with an aqueous solution of sodium carbonate in the vacuum mixer, and starting the vacuum mixer for dough mixing to obtain crumbly dough;

(4) leaving the crumbly dough obtained in the step (3) to rest at room temperature to prepare dough;

(5) sheeting the dough obtained in the step (4) to obtain a dough sheet;

(6) cutting the dough sheet obtained in the step (5) to obtain long strips, hanging them on noodle rods, and drying to obtain long strips of buckwheat dried noodles;

(7) cutting the long strips of buckwheat dried noodles obtained in the step (6) to obtain short strips, and weighing and packaging them to obtain the high-content buckwheat dried noodles.

Further, the buckwheat grains include common buckwheat grains and tartary buckwheat grains. In the present disclosure, the common buckwheat grains and the tartary buckwheat grains are mixed at any ratio, which can reduce the bitter taste of tartary buckwheat and improve the nutritional value of the whole buckwheat flour.

As one of the preferred solutions, the step (1) comprises: providing buckwheat grains, subjecting the buckwheat grains to disinfestation and sterilization treatments, and then pulverizing them to obtain whole buckwheat flour.

Further, the disinfestation and sterilization treatments may use ozone water or slightly acidic electrolyzed water to wash and temper the buckwheat grains so that the final moisture is 13.0-16.0 wt % to achieve the effect of sterilization, and then implement superheated steam treatment, radio frequency heating treatment or microwave treatment to achieve the effect of killing insect eggs, sterilization and inactivating enzymes.

Further, the disinfestation and sterilization treatments comprise washing and tempering with slightly acidic electrolyzed water in combination with radio frequency heating.

Further, the slightly acidic electrolyzed water has a concentration of available chlorine of 30-70 ppm and a pH value of 5.8-6.2. the radio frequency heating treatment is controlled to have a resonant frequency of 20-45 MHz, power of 5-20 kW and distance between the polar plates of 40-120 mm, the thickness of the buckwheat grains on the conveyor belt is 20-50 mm, the treatment time is 180-600 s, and the temperature at which the buckwheat grains discharged from the radio-frequency cavity is 50-90° C.

The slightly acidic electrolyzed water used in the present disclosure features strong wide-spectrum sterilization ability, no pollution, no residue, high safety and reliability, non-toxicity and harm to the human body, no skin irritation, convenient preparation, and low price. In addition, it can wet buckwheat grains, which facilitates seed husk shedding. Also, it can kill microorganisms on the surface of buckwheat grains.

The radio frequency heating treatment technology used in the present disclosure has become a research hotspot in the field of agricultural products and food sterilization. Compared with traditional heat treatment, it can reduce the heat treatment time and selectively heat insects. Therefore, it does not affect the quality of the material to be processed while ensuring effective killing of insects.

Therefore, the present disclosure adopts slightly acidic electrolyzed water combined with radio-frequency heating treatment technology to pretreat buckwheat, which can achieve the purposes of completely killing insect eggs, sterilizing and inactivating enzymes, thereby extending the shelf life of whole buckwheat flour and dried noodle products thereof under the premise of ensuring product quality.

Further, the step (1) comprises: grinding the buckwheat grains obtained after the disinfestation and sterilization treatments, and then subjecting them to ultrafine pulverization or low-temperature vortex pulverization to obtain whole buckwheat flour; or alternatively, grinding the buckwheat grains obtained after the disinfestation and sterilization treatments using a roller flour mill to obtain buckwheat core powder and buckwheat bran powder, subjecting the buckwheat bran powder to ultrafine pulverization or low-temperature vortex pulverization, and then mixing the resultant buckwheat bran powder with the buckwheat core powder to obtain whole buckwheat flour.

Further, the whole buckwheat flour is prepared by grinding in an impact grinder in combination with multi-milling in a stone mill, and the whole buckwheat flour is subjected to ultrafine pulverization or low-temperature vortex pulverization or roller-milling to obtain buckwheat core powder and bran powder. The buckwheat bran powder is further subjected to ultrafine pulverization or low-temperature vortex pulverization, and then added back to the buckwheat core powder to obtain whole buckwheat flour. In this way, the powder particle size can be reduced to prevent the coarse bran component from hindering the formation of the gluten network structure, thereby enhancing the texture and taste of the product.

Further, the whole buckwheat flour is preferably prepared by roller milling in combination with low-temperature vortex pulverization, with the temperature controlled at 10-35° C., and the particle size 80-200 mesh. This method can prevent oxidation of flavonoids in buckwheat bran under low temperature conditions, and has less damage to nutrients such as flavonoids in buckwheat.

In some embodiments, the step (2) specifically includes well mixing whole buckwheat flour, high-gluten wheat flour, vital wheat gluten, resistant starch, egg white powder, sodium alginate, konjac flour, glutamine aminotransferase, hemicellulase and phytase for 1-6 min, and putting the resultant mixture into a vacuum mixer to obtain a mixed powder.

In some embodiments, the step (3) includes mixing in a vacuum mixer at a high speed and then a low speed under a vacuum degree of −0.08 to −0.04 MPa for 5-15 min to obtain crumbly dough.

In some embodiments, the resting time of crumbly dough in the step (4) is 8-20 min.

Further, the sheeting in the step (5) is 4 to 8 passes.

In some embodiments, the drying described in the step (6) is conducted by a ropeway drying method for 4-6 h.

Further, the drying is performed by a five-stage drying method, which specifically comprises: (1) shaping with cold air at a temperature of 25-30° C. and a relative humidity of 85-90%; (2) low-speed dehydration at a temperature of 39-45° C. and a relative humidity of 78-85%; (3) high-speed dehydration at a temperature of 42-46° C. and a relative humidity of 70-76%; (4) cooling down to temper at a temperature of 34-36° C. and a relative humidity of 56-60%; (5) extended tempering at room temperature for a period of time.

In summary, the present disclosure further increases the amount of buckwheat flour added to the dried noodles by the following technical methods, and makes high-content buckwheat dried noodles with good quality. First, vacuum mixing technology: vacuum mixing can make the raw materials mix more evenly and increase the water content; and it is conducive to the rapid formation of gluten network structure, improve the quality of the dried noodle, so that the dried noodle has a uniform color without color difference, and is obviously better than ordinary dried noodles in elasticity, hardness, cooking resistance and taste. Second, the optimization of the formula: ordinary vital wheat gluten, konjac flour, sodium alginate, etc. are used to improve the quality of dough, improve the ductility of dough, and increase the hardness and toughness of dried noodles, so that the buckwheat dried noodles have better sensory quality and texture characteristics. Third, enzyme modification: it strengthens protein cross-linking, removes phytic acid substances and degrades cellulose substances in whole buckwheat flour, thereby improving the quality and nutritional value of dried noodles.

The technical solution of the present disclosure is further described in detail through several examples below. However, these examples are only used to illustrate the present disclosure and do not limit the scope of the present disclosure.

Unless otherwise specified, the experimental methods used in the following examples are conventional methods; the reagents, materials, etc. used in the following examples can be commercially available unless otherwise specified.

### Example 1

(1) Preparation of Pretreated Whole Buckwheat Flour

1) Disinfestation and Sterilization of Buckwheat Grains

Clean buckwheat grains were mixed with slightly acidic electrolyzed water which has a concentration of available chlorine of 30 ppm and a pH of 6.2, so that the final moisture of the buckwheat grains was 13.0 wt %. The treated buckwheat grains were placed in a microwave device to treat at 80° C. for 5 min.

2) Grinding in Stone Mill

The pre-processed buckwheat grains were put into a stone mill to grind for multiple passes to obtain whole buckwheat flour.

3) Ultrafine Pulverization

The whole buckwheat flour was put into an ultrafine pulverizer to pulverize for 10 min to obtain 80-mesh whole buckwheat flour.

(2) Production of Dried Noodles

1) Dry Powder Mixing

60 kg of whole buckwheat flour, 30 kg of high-gluten wheat flour, 15 kg of resistant starch, 5 kg of vital wheat gluten, 0.5 kg of egg white powder, 0.01 kg of sodium alginate, 0.01 kg of konjac flour, 5 U/g glutamine transaminase, 50 U/g of hemicellulase and 50 U/g phytase were weighed and put into a vacuum mixing pot where they were mixed for 1 min to obtain a powdery raw material.

2) Mixing

0.01 kg of sodium carbonate was pre-dissolved in 32 kg of water, and the resulting solution was added to the vacuum mixer for mixing under a vacuum degree of −0.04 MPa for 15 min to obtain crumbly dough.

3) Resting

The crumbly dough was left to rest on the resting belt for 8 min.

4) Sheeting and Cutting

The rested crumbly dough was passed through 4 sheeting rollers and cut into noodles.

5) Drying

Five-stage drying, which comprises (1) shaping with cold air at a temperature of 25° C. and a relative humidity of 85%; (2) low-speed dehydration at a temperature of 39° C. and a relative humidity of 78%; (3) high-speed dehydration at a temperature of 42° C. and a relative humidity of 70%; (4) cooling down to temper at a temperature of 34° C. and a relative humidity of 56%; (5) extended tempering at room temperature for a period of time.

6) Cutting, Weighing and Packaging

The finished dried noodles were cut into short strips, weighed and packaged.

Table 1 shows the nutrients of the obtained dried noodles.

TABLE 1
Nutrients of the dried noodles obtained in Example 1

| | | |
|---|---|---|
| Item | per 100 g dried noodles | NRV % |

| | | | |
|---|---|---|---|
| Energy | 1493 | kJ | 18% |
| Protein | 17.1 | g | 28% |
| Fat | 1.9 | g | 3% |
| Carbohydrate | 70.9 | g | 24% |
| Dietary fiber | 6.0 | g | 24% |
| Sodium | 16 | mg | 1% |

### Example 2

(1) Preparation of Pretreated Whole Buckwheat Flour

1) Disinfestation and Sterilization of Buckwheat Grains

Clean buckwheat grains were mixed with ozone water with an ozone concentration of 2.53 mg/L, so that the final moisture of the buckwheat grains was 14.3 wt %. The treated buckwheat grains were placed on a conveyor belt in the center of the lower polar plate in the radio frequency processing cavity, wherein the grains thickness was 20 mm, the working frequency was 27.12 MHz, the power was 5 Kw, the plate spacing was 40 mm, the processing time was 180 s, the conveyor belt was reciprocated for radio frequency disinfestation, and the temperature of buckwheat grains discharged from the radio frequency cavity was controlled at 50° C.

2) Grinding in Stone Mill

The pre-processed buckwheat grains were put into a stone mill to grind for multiple passes to obtain whole buckwheat flour.

3) Low Temperature Vortex Pulverization

The whole buckwheat flour was put into a low-temperature vortex pulverizer to pulverize at 35° C. for 10 min to obtain an 80-mesh, uniformly refined whole buckwheat flour.

(2) Production of Dried Noodles

1) Dry Powder Mixing

80 kg of whole buckwheat flour, 18 kg of high-gluten wheat flour, 10 kg of vital wheat gluten, 2 kg of resistant starch, 1 kg of egg white powder, 0.08 kg of konjac flour, 0.1 kg of sodium alginate, 10 U/g glutamine transaminase, 60 U/g hemicellulase, 90 U/g phytase were put into a vacuum mixer where they were mixed for 3 min to obtain a powdery raw material.

2) Mixing

0.08 kg of sodium carbonate was pre-dissolved in 30 kg of water, and the resulting solution was added to the vacuum mixer for dough mixing under a vacuum degree of −0.05 MPa for 12 min to obtain crumbly dough.

3) Resting

The dough was left to rest on the resting belt for 10 min.

4) Sheeting and Cutting

The rested dough was passed through 5 sheeting rollers and cut into noodles.

5) Drying

Five-stage drying, which comprises (1) shaping with cold air at a temperature of 30° C. and a relative humidity of 90%; (2) low-speed dehydration at a temperature of 45° C. and a relative humidity of 85%; (3) high-speed dehydration at a temperature of 46° C. and a relative humidity of 76%; (4) cooling down to temper at a temperature of 36° C. and a relative humidity of 60%; (5) extended tempering at room temperature for a period of time.

6) Cutting, Weighing and Packaging

The finished dried noodles were cut into short strips, weighed and packaged.

Table 2 shows the nutrients of the obtained dried noodles.

TABLE 2
Nutrients of the dried noodles obtained in Example 2

| | | |
|---|---|---|
| Item | per 100 g dried noodles | NRV % |

| | | | |
|---|---|---|---|
| Energy | 1500 | kJ | 18% |
| Protein | 19.1 | g | 32% |
| Fat | 2.4 | g | 4% |
| Carbohydrate | 69.3 | g | 23% |
| Dietary fiber | 7.8 | g | 31% |
| Sodium | 26 | mg | 1% |

### Example 3

(1) Preparation of Pretreated Buckwheat Flour

1) Disinfestation and Sterilization of Buckwheat Grains

Clean buckwheat grains were mixed with slightly acidic electrolyzed water which has a concentration of available chlorine of 60 ppm and a pH of 6.10, so that the final moisture of the buckwheat grains was 15.0 wt %. The treated buckwheat grains were placed on a conveyor belt in the center of the lower polar plate in the radio frequency processing cavity, wherein the grains thickness was 30 mm, the working frequency was 45 MHz, the power was 9 Kw, the plate spacing was 80 mm, and the radio frequency processing time was 300 s, the conveyor belt was reciprocated for radio frequency disinfestation, and the temperature of buckwheat grains discharged from the radio frequency cavity was controlled at 65° C.

2) Milling with Roller Flour Mill

the pre-treated buckwheat grains are placed into a roller flour mill for pulverization, and the resultant powder is sieved to obtain buckwheat core powder and bran powder.

3) Low Temperature Vortex Pulverization

The buckwheat bran powder was put into a low-temperature vortex pulverizer to pulverize at 20° C. for 12 min to obtain an 120-mesh, uniformly refined flour, and then mixing the resultant buckwheat bran powder with the buckwheat core powder to obtain whole buckwheat flour.

(2) Production of Dried Noodles

1) Dry Powder Mixing

80 kg of whole buckwheat flour, 15 kg of high-gluten wheat flour, 10 kg of vital wheat gluten, 5 kg of resistant starch, 1.5 kg of egg white powder, 0.1 kg of konjac flour, 0.2 kg of sodium alginate, 25 U/g glutamine transaminase, 120 U/g hemicellulase, 200 U/g phytase were put into a vacuum mixer where they were mixed for 4 min to obtain a powdery raw material.

2) Mixing

0.1 kg of sodium carbonate was pre-dissolved in 28 kg of water, and the resulting solution was added to the vacuum mixer for dough mixing under a vacuum degree of −0.06 MPa for 10 min to obtain crumbly dough.

3) Resting

The dough was left to rest on the resting belt for 15 min.

4) Sheeting and Cutting

The rested dough was passed through 6 sheeting rollers and cut into noodles.

5) Drying

Five-stage drying, which comprises (1) shaping curing with cold air at a temperature of 28° C. and a relative humidity of 88%; (2) low-speed dehydration at a temperature of 42° C. and a relative humidity of 80%; (3) high-speed dehydration at a temperature of 44° C. and a relative humidity of 73%; (4) cooling down to temper at a temperature of 35° C. and a relative humidity of 58%; (5) extended tempering at room temperature for a period of time.

6) Cutting, Weighing and Packaging

The finished dried noodles were cut into short strips, weighed and packaged.

Table 3 shows the nutrients of the obtained dried noodles.

TABLE 3
Nutrients of the dried noodles obtained in Example 3

| | | |
|---|---|---|
| Item | per 100 g dried noodles | NRV % |

| | | | |
|---|---|---|---|
| Energy | 1491 | kJ | 18% |
| Protein | 19.2 | g | 32% |
| Fat | 2.4 | g | 4% |
| Carbohydrate | 69.9 | g | 23% |
| Dietary fiber | 7.8 | g | 31% |
| Sodium | 38 | mg | 2% |

### Example 4

(1) Preparation of Pretreated Whole Buckwheat Flour

1) Disinfestation and Sterilization of Buckwheat Grains

Clean buckwheat grains were mixed with slightly acidic electrolyzed water which has a concentration of available chlorine of 70 ppm and a pH of 5.8, so that the final moisture of the buckwheat grains was 15.5 wt %. The treated buckwheat grains were placed on a conveyor belt in the center of the lower polar plate in the radio frequency processing cavity, wherein the grains thickness was 50 mm, the working frequency was 20 MHz, the power was 20 Kw, the plate spacing was 120 mm, and the radio frequency processing time was 600 s, the conveyor belt was reciprocated for radio frequency disinfestation, and the temperature of buckwheat grains discharged from the radio frequency cavity was controlled at 90° C.

2) Grinding with Roller Flour Mill Impact Grinder

The pre-processed buckwheat grains were put into an impact grinder to grind for multiple passes to obtain whole buckwheat flour.

3) Low Temperature Vortex Pulverization

The whole buckwheat flour was put into a low-temperature vortex pulverizer to pulverize at 10° C. for 15 min to obtain 200-mesh whole buckwheat flour.

(2) Production of Dried Noodles

1) Dry Powder Mixing

90 kg of whole buckwheat flour, 15 kg of high-gluten wheat flour, 10 kg of vital wheat gluten, 2 kg of resistant starch, 2 kg of egg white powder, 0.12 kg of konjac flour, 0.4 kg of sodium alginate, 40 U/g glutamine transaminase, 200 U/g hemicellulase, 400 U/g phytase were put into a vacuum mixer where they were mixed for 5 min to obtain a powdery raw material.

2) Mixing

0.12 kg of sodium carbonate was pre-dissolved in 27 kg of water, and the resulting solution was added to the vacuum mixer for dough mixing under a vacuum degree of −0.07 MPa for 8 min to obtain crumbly dough.

3) Resting

The dough was left to rest on the resting belt for 18 min.

4) Sheeting and Cutting

The rested dough was passed through 8 sheeting rollers and cut into noodles.

5) Drying

Five-stage drying, which comprises (1) shaping with cold air at a temperature of 26° C. and a relative humidity of 86%; (2) low-speed dehydration at a temperature of 40° C. and a relative humidity of 82%; (3) high-speed dehydration at a temperature of 43° C. and a relative humidity of 72%; (4) cooling down to temper at a temperature of 34° C. and a relative humidity of 57%; (5) extended tempering at room temperature for a period of time.

6) Cutting, Weighing and Packaging

The finished dried noodles were cut into short strips, weighed and packaged.

Table 4 shows the nutrients of the obtained dried noodles.

TABLE 4
Nutrients of the dried noodles obtained in Example 4

| Item | per 100 g dried noodles | NRV % |
|---|---|---|
| Energy | 1496 kJ | 18% |
| Protein | 19.6 | 33% |
| Fat | 2.5 | 4% |
| Carbohydrate | 65.1 | 22% |
| Dietary fiber | 8.3 | 33% |
| Sodium | 61 | 3% |

### Example 5

(1) Preparation of Pretreated Whole Buckwheat Flour

1) Disinfestation and Sterilization of Buckwheat Grains:

Clean buckwheat grains were mixed with ozone water with an ozone concentration of 1.86 mg/L, so that the final moisture of the buckwheat grains was 16.0 wt %. The treated buckwheat grains were put into a superheated steam treatment equipment at a temperature of 185° C. for 90 s.

2) Milling with Roller Flour Mill:

the pre-treated buckwheat grains are placed into a roller flour mill for pulverization, and the resultant powder is sieved to obtain buckwheat core powder and bran powder.

3) Ultrafine Pulverization:

The buckwheat bran powder was put into an ultrafine pulverizer to pulverize for 15 min, to obtain 150-mesh whole buckwheat flour, which was then added back to buckwheat core flour to obtain whole buckwheat flour.

(2) Production of Dried Noodles

1) Dry Powder Mixing

90 kg of whole buckwheat flour, 15 kg of high-gluten wheat flour, 5 kg of vital wheat gluten, 1 kg of resistant starch, 3 kg of egg white powder, 0.15 kg of konjac flour, 0.5 kg of sodium alginate, 60 U/g glutamine transaminase, 400 U/g hemicellulase, 60 U/g phytase were put into a vacuum mixer where they were mixed for 6 min to obtain a powdery raw material.

2) Mixing

0.15 kg of sodium carbonate was pre-dissolved in 25 kg of water, and the resulting solution was added to the vacuum mixer for dough mixing under a vacuum degree of −0.08 MPa for 5 min to obtain crumbly dough.

3) Resting

The dough was left to rest on the resting belt for 20 min.

4) Sheeting and Cutting

The rested dough was passed through 8 sheeting rollers and cut into noodles.

5) Drying

Five-stage drying, which comprises (1) shaping curing with cold air at a temperature of 29° C. and a relative humidity of 89%; (2) low-speed dehydration at a temperature of 44° C. and a relative humidity of 84%; (3) high-speed dehydration at a temperature of 45° C. and a relative humidity of 74%; (4) cooling down to temper at a temperature of 36° C. and a relative humidity of 59%; (5) extended tempering at room temperature for a period of time.

6) Cutting, Weighing and Packaging

The finished dried noodles were cut into short strips, weighed and packaged.

Table 5 shows the nutrients of the obtained dried noodles.

TABLE 5
Nutrients of the dried noodles obtained in Example 5

| Item | per 100 g dried noodles | NRV % |
|---|---|---|
| Energy | 1497 kJ | 18% |
| Protein | 19.8 | 33% |
| Fat | 2.5 | 4% |
| Carbohydrate | 65.3 | 22% |
| Dietary fiber | 8.4 | 34% |
| Sodium | 85 | 4% |

### Comparative Example 1

(1) Preparation of Whole Buckwheat Flour

The buckwheat grains were cleaned and tempered, and then pulverized in a roller mill and sieved to obtain buckwheat core powder and bran powder.

(2) The Production of Dried Noodles

1) Dry Powder Mixing

80 kg of whole buckwheat flour, 18 kg of high-gluten wheat flour, 10 kg of vital wheat gluten, 0.08 kg of konjac flour, 0.1 kg of sodium alginate were put into a vacuum mixer where they were mixed for 6 min to obtain a powdery raw material.

2) Mixing

0.15 kg of sodium carbonate was pre-dissolved in 25 kg of water, and the resulting solution was added to the vacuum mixer for dough mixing under a vacuum degree of −0.08 MPa for 5 min to obtain crumbly dough.

3) Resting

The dough was left to rest on the resting belt for 20 min.

4) Sheeting and Cutting

The rested dough was passed through 8 sheeting rollers and cut into noodles.

5) Drying

Five-stage drying, which comprises (1) shaping with cold air at a temperature of 29° C. and a relative humidity of 89%; (2) low-speed dehydration at a temperature of 44° C. and a relative humidity of 84%; (3) high-speed dehydration at a temperature of 45° C. and a relative humidity of 74%; (4) cooling down to temper at a temperature of 36° C. and a relative humidity of 59%; (5) extended tempering at room temperature for a period of time.

6) Cutting, Weighing and Packaging

The finished dried noodles were cut into short strips, weighed and packaged.

### Comparative Example 2

(1) Preparation of Whole Buckwheat Flour

1) Milling with Roller Flour Mill

the buckwheat grains are placed into a roller flour mill for pulverization, and the resultant powder is sieved to obtain buckwheat core powder and bran powder.

2) Ultrafine Pulverization:

The buckwheat bran powder was put into an ultrafine pulverizer to pulverize for 15 min, to obtain 150-mesh whole buckwheat flour, which was then added back to buckwheat core flour to obtain whole buckwheat flour.

(2) Preparation of Dried Noodles

1) Dry Powder Mixing

80 kg of whole buckwheat flour, 18 kg of high-gluten wheat flour, 10 kg of vital wheat gluten, 0.2 kg of resistant starch, 0.2 kg of egg white powder, 0.08 kg of konjac flour, 0.1 kg of sodium alginate, 2 U/g glutamine transaminase, 30 U/g hemicellulase, 30 U/g phytase were put into a vacuum mixer where they were mixed for 6 min to obtain a powdery raw material.

2) Mixing

0.08 kg of sodium carbonate was pre-dissolved in 25 kg of water, and the resulting solution was added to the vacuum mixer for dough mixing under a vacuum degree of −0.08 MPa for 5 min to obtain crumbly dough.

3) Resting

The dough was left to rest on the resting belt for 20 min.

4) Sheeting and Cutting

The rested dough was passed through 8 sheeting rollers and cut into noodles.

5) Drying

Five-stage drying, which comprises (1) shaping with cold air at a temperature of 29° C. and a relative humidity of 89%; (2) low-speed dehydration at a temperature of 44° C. and a relative humidity of 84%; (3) high-speed dehydration at a temperature of 45° C. and a relative humidity of 74%; (4) cooling down to temper at a temperature of 36° C. and a relative humidity of 59%; (5) extended tempering at room temperature for a period of time.

6) Cutting, Weighing and Packaging

The finished dried noodles were cut into short strips, weighed and packaged.

### Comparative Example 3

(1) Preparation of Pretreated Whole Buckwheat Flour

1) Disinfestation and Sterilization of Buckwheat Grains

Clean buckwheat grains were mixed with slightly acidic electrolyzed water which has a concentration of available chlorine of 80 ppm and a pH of 6.8, so that the final moisture of the buckwheat grains was 15.0 wt %. The treated buckwheat grains were placed on a conveyor belt in the center of the lower polar plate in the radio frequency processing cavity, wherein the grains thickness was 30 mm, the working frequency was 50 MHz, the power was 30 Kw, the plate spacing was 80 mm, and the radio frequency processing time was 800 s, the conveyor belt was reciprocated for radio frequency disinfestation, and the temperature of buckwheat grains discharged from the radio frequency cavity was controlled at 100° C.

2) Grinding in Stone Mill

The pre-processed buckwheat grains were put into a stone mill to grind for multiple passes to obtain whole buckwheat flour.

3) Low Temperature Vortex Pulverization

The whole buckwheat flour was put into a low-temperature vortex pulverizer to pulverize at 35° C. for 10 min to obtain an 80-mesh, uniformly refined whole buckwheat flour.

(2) Preparation of Dried Noodles

1) Dry Powder Mixing

80 kg of whole buckwheat flour, 18 kg of high-gluten wheat flour, 10 kg of vital wheat gluten, 20 kg of resistant starch, 4 kg of egg white powder, 0.6 kg of sodium alginate, 0.08 kg of konjac flour, 80 U/g glutamine aminotransferase, 500 U/g hemicellulase, and 500 U/g phytase powder were put into a vacuum mixer where they were mixed for 6 min to obtain a powdery raw material.

2) Mixing

0.08 kg of sodium carbonate was pre-dissolved in 25 kg of water, and the resulting solution was added to the vacuum mixer for dough mixing under a vacuum degree of −0.08 MPa for 5 min to obtain crumbly dough.

3) Resting

The dough was left to rest on the resting belt for 20 min.

4) Sheeting and Cutting

The rested dough was passed through 8 sheeting rollers and cut into noodles.

5) Drying

Five-stage drying, which comprises (1) shaping with cold air at a temperature of 29° C. and a relative humidity of 89%; (2) low-speed dehydration at a temperature of 44° C. and a relative humidity of 84%; (3) high-speed dehydration at a temperature of 45° C. and a relative humidity of 74%; (4) cooling down to temper at a temperature of 36° C. and a relative humidity of 59%; (5) extended tempering at room temperature for a period of time.

6) Cutting, Weighing and Packaging

The finished dried noodles were cut into short strips, weighed and packaged.

### Comparative Example 4: Dried Wheat Noodles

Referring to Example 1, the dry powder mixing conditions in the method for making dried noodles in the step (2) were replaced by the following: 100 kg of high-gluten wheat flour, 0.5 kg of egg white powder, 0.01 kg of sodium alginate, and 0.01 kg of konjac flour were weighed and put into a vacuum mixer and mixed for 1 min to obtain a powdery raw material; the dough mixing conditions the method for making dried noodles in the step (2) were replaced by the following: 0.01 kg of sodium carbonate was dissolved in 30 kg of water in advance, and the resulting solution was added to the vacuum mixer for dough mixing at a vacuum degree of −0.04 MPa for 15 min to obtain crumbly dough, with the other conditions unchanged, thereby obtaining wheat dried noodles.

The nutrients of the dried noodles obtained in Comparative Examples 1-4 were detected, as shown in Table 6 below.

TABLE 6
Nutrients of buckwheat dried noodles of Comparative Examples 1-4

| | Comparative Example 4 | | | Comparative | | | Comparative | | | Comparative | | |
|---|---|---|---|---|---|---|---|---|---|---|---|---|
| | (Dried wheat noodles) | | | Example 1 | | | Example 2 | | | Example 3 | | |
| Item | Per 100 g | | NRV % | Per 100 g | | NRV % | Per 100 g | | NRV % | Per 100 g | | NRV % |
| Energy | 1475 | kJ | 18% | 1490 | kJ | 18% | 1488 | kJ | 18% | 1499 | kJ | 18% |
| Protein | 11.0 | g | 18% | 19.3 | g | 32% | 19.2 | g | 32% | 19.3 | g | 32% |
| Fat | 1.0 | g | 2% | 2.3 | g | 4% | 2.3 | g | 4% | 2.3 | g | 4% |
| Carbohydrate | 73.3 | g | 24% | 69.0 | | 23% | 69.1 | | 23% | 68.6 | | 23% |
| Dietary fiber | 0.8 | g | 3% | 7.8 | | 31% | 7.7 | | 31% | 7.6 | | 30% |
| Sodium | 1200 | mg | 25% | 27 | mg | 1% | 28 | mg | 1% | 94 | mg | 5% |

As shown in the table 1-6, the high-content buckwheat dried noodles prepared by the present disclosure, that is, the buckwheat dried noodles of the examples have a dietary fiber content of 6.0-7.8 g/100 g, which is much higher than 0.8 g/100 g of wheat dried noodles, so that it is a good source of dietary fiber. Also, it is rich in protein, and the protein content of the buckwheat dried noodles of the examples is 17.1-19.8 g/100 g, which is higher than that of the wheat dried noodles. While controlling post-prandial blood sugar generation, it can provide high plant protein, so that it is an ideal staple food for diabetics and obese patients. Compared to the wheat dried noodles, it contains no salt in its formula. The sodium content of the buckwheat dried noodles of the examples is 16-85 mg/100 g, so that the buckwheat dried noodle of the present disclosure is a “low sodium” product, which conforms to the concept of healthy “low salt diet” and helps prevent hypertension. Therefore, it is a healthy high-content buckwheat dried noodle. Compared with the examples, Comparative Example 3 has a high sodium content of 94 mg/100 g.

### Example 6: Quality Evaluation of Dried Noodles

The experimental materials are the dried noodle products prepared in Examples 1-5 and Comparative Examples 1-4.

Dried Noodle Quality Index Detection:

The acidity was measured according to the method specified in GB 5009.239; the moisture was measured according to the method specified in GB 5009.3; the natural breaking rate, cooking breaking rate, optimal cooking time and cooking loss were measured according to LS/T 3212.

The quality indexes of buckwheat dried noodles and wheat dried noodles obtained in the examples and comparative examples were tested, and the results are shown in Table 7 and 8 below.

TABLE 7
Test results of quality indexes of buckwheat dried noodles obtained in Examples 1-5

| Index | | | | | | |
|---|---|---|---|---|---|---|
| type | Item | Example 1 | Example 2 | Example 3 | Example 4 | Example 5 |
| Basic | Moisture/(%) | 12.0 | 11.6 | 11.5 | 11.5 | 11.3 |
| indexes | Acidity/ | 1.5 | 1.8 | 2.0 | 1.9 | 2.3 |
| | (mL/10 g) | | | | | |
| | Color | Even | Even | Even | Even | Even |
| | Taste | After cooking, | After cooking, | After cooking, | After cooking, | After cooking, |
| | | it is not sticky, | it is not sticky, | it is not sticky, | it is not sticky, | it is not sticky, |
| | | has good | has good | has good | has good | has good |
| | | toughness, is | toughness, is | toughness, is | toughness, is | toughness, is |
| | | chewy, | moderately | moderately | moderately | moderately |
| | | smooth, | smooth and | smooth and | smooth and | smooth and |
| | | palatable, and | palatable, and | palatable, and | palatable, and | palatable, and |
| | | has buckwheat | has buckwheat | has buckwheat | has buckwheat | has buckwheat |
| | | flavor | flavor | flavor | flavor | flavor |
| Rating | Natural | 2 | 3 | 3 | 5 | 4 |
| indexes | breaking | | | | | |
| | rate/(%) | | | | | |
| | Cooking | 0 | 0 | 0 | 0 | 0 |
| | breaking | | | | | |
| | rate/(%) | | | | | |
| | Cooking | 3.5 | 8.2 | 8.0 | 8.6 | 8.8 |
| | loss/(%) | | | | | |
| | Optimal | 3 min 55 s | 3 min 50 s | 3 min 50 s | 3 min 50 s | 3 min 50 s |
| | cooking | | | | | |
| | time | | | | | |

TABLE 8
Test results of quality index of buckwheat dried noodles

| Index | | Comparative | Comparative | Comparative | Comparative |
|---|---|---|---|---|---|
| type | Item | Example 1 | Example 2 | Example 3 | Example 4 |
| Basic | Moisture/(%) | 11.5 | 11.7 | 11.8 | 12.5 |
| indexes | Acidity/(mL/10 g) | 1.9 | 1.8 | 1.8 | 1.3 |
| | Color | Even | Even | Even | Even |
| | Taste | After cooking, it | After cooking, it | After cooking, it | After cooking, it |
| | | tastes extremely | tastes rough, | is not sticky, is | is not sticky, |
| | | rough, slightly | slightly hard | hard, fragile, | has good |
| | | hard, and sticky, | and sticky, and | moderately | toughness, is |
| | | and has | has buckwheat | smooth, and has | chewy, smooth, |
| | | buckwheat flavor | flavor | buckwheat | moderately |
| | | | | flavor | palatable, and |
| | | | | | has buckwheat |
| | | | | | flavor |
| Rating | Natural | 5 | 4 | 4 | 1 |
| indexes | breaking | | | | |
| | rate/(%) | | | | |
| | Cooking | 0 | 0 | 0 | 0 |
| | breaking | | | | |
| | rate/(%) | | | | |
| | Cooking | 9.6 | 9.3 | 8.6 | 3.5 |
| | loss/(%) | | | | |
| | Optimal | 3 min 45 s | 3 min 50 s | 4 min 5 s | 4 min 10 s |
| | cooking time | | | | |

According to the data in the table 7 and 8, compared with wheat dried noodles, high-content buckwheat dried noodles have a higher cooking loss rate and a shorter cooking time. This is because buckwheat does not contain gluten protein and has a large amount of broken starch, which results in a high cooking loss rate, but it is within the acceptable range of dried multi-grain noodles. The dried noodle prepared by the present disclosure complies with the specifications on dried multi-grain noodles as stated in LS/T 3304 The Grain and Oil Products of China—Dried Noodles. Compared with the comparative examples, the buckwheat dried noodles of the examples taste smooth, have good toughness, moderate palatability, and low cooking loss rate. Comparative Example 1 does not use ultrafine pulverization or low-temperature vortex pulverization to process the whole buckwheat flour, and its dried noodles taste extremely rough and have a high cooking loss rate. In Comparative Example 3, the excessive amount of the quality improver added causes the dried buckwheat noodles to taste too hard and brittle, which does not meet consumer preferences. This shows that the present disclosure can significantly improve the quality of high-content buckwheat dried noodles.

TPA Test of Dried Noodles:

The buckwheat dried noodles were cooked for an optimal cooking time, cooked noodles with a uniform appearance and texture were selected, 6 pieces for each group of samples, which were placed at equal intervals in the middle of the stage while ensuring that the noodles were parallel to each other and the surface of the noodles was flat and upward. The measurement parameters were set as follows: pre-test speed 2.0 mm/s, test speed 0.8 mm/s, post-test speed 0.8 mm/s, compression rate 70%, Trigger Type Auto-5 g, time interval between compressions 1 s, Probe model HDP/PFS. Each group of samples needed to be tested repeatedly more than 6 times. The TPA test can provide the hardness, cohesiveness, resilience and springiness of the dried noodles.

The TPA test was performed on the dried buckwheat noodles and wheat noodles obtained in the examples and comparative examples. The results are shown in Table 9 below.

TABLE 9
TPA test results of dried buckwheat noodles obtained by different processes

| | Hardness | Cohesiveness | Resilience | springiness |
|---|---|---|---|---|
| Example 1 | 3961.45 ± 127.98 | 0.90 ± 0.02 | 0.68 ± 0.02 | 0.88 ± 0.02 |
| Example 2 | 4167.24 ± 262.51 | 0.94 ± 0.01 | 0.63 ± 0.01 | 0.83 ± 0.02 |
| Example 3 | 3526.34 ± 126.95 | 0.92 ± 0.02 | 0.69 ± 0.02 | 0.84 ± 0.04 |
| Example 4 | 4564.52 ± 112.35 | 0.81 ± 0.01 | 0.61 ± 0.01 | 0.81 ± 0.03 |
| Example 5 | 4434.26 ± 246.18 | 0.84 ± 0.01 | 0.62 ± 0.02 | 0.81 ± 0.02 |
| Comparative | 4803.34 ± 188.07 | 0.9 ± 0.01 | 0.53 ± 0.03 | 0.75 ± 0.02 |
| Example 1 | | | | |
| Comparative | 4941.52 ± 99.09 | 0.89 ± 0.01 | 0.62 ± 0.02 | 0.81 ± 0.03 |
| Example 2 | | | | |
| Comparative | 6873.33 ± 109.27 | 0.95 ± 0.01 | 0.51 ± 0.02 | 0.77 ± 0.03 |
| Example 3 | | | | |
| Comparative | 3722.56 ± 151.23 | 0.93 ± 0.01 | 0.74 ± 0.01 | 0.91 ± 0.01 |
| Example 4 | | | | |

With the increase in the amount of buckwheat flour, the hardness of the dried noodles increases, and the resilience and springiness decrease. The main reason is that the fiber component in the whole buckwheat flour acts as a spatial barrier to the gluten network. Non-starch polysaccharides compete with the gluten network to absorb water, and buckwheat has a low content of gluten protein. As a result, the texture characteristics of the dried noodles deteriorate. The data in Table 5 show that the values of indexes including hardness, cohesiveness, resilience, and springiness of the buckwheat dried noodles in the examples are all within a reasonable range, and are not significantly different from these of the wheat dried noodles, which effectively avoids the problems of failure to rolling, sticking to the roller and high breaking rate resulting from the addition of high-content buckwheat flour during the production process of buckwheat dried noodles. The buckwheat dried noodles in the comparative examples have high hardness and low resilience and springiness. As a result, the finished products taste hard, brittle, and have poor toughness, so that they could hardly be accepted by the consumers. This is consistent with the taste evaluation results in Table 4. Among them, the hardness value of dried noodles of Comparative Example 3 reached 6873.33±109.27, and the resilience and springiness of buckwheat dried noodles of Comparative Example 1 and Comparative Example 3 were too low. This shows that the vortex pulverization or ultrafine pulverization of bran, together with the reasonable use of enzymatic preparations, egg white powder, resistant starch and other quality improvers, can significantly improve the texture characteristics of buckwheat dried noodles.

Storage Test of Dried Noodles:

The high-content buckwheat dried noodles and wheat dried noodles of the examples and comparative examples were tested for storage life, and the results are shown in Table 10 below.

TABLE 10
Test results of storage life of dried noodles

| | Shelf life/d | Infestation rate/% |
|---|---|---|
| Example 1 | 303 | 0 |
| Example 2 | 280 | 0 |
| Example 3 | 286 | 0 |
| Example 4 | 275 | 0 |
| Example 5 | 270 | 0 |
| Comparative | 110 | 13 |
| Example 1 | | |
| Comparative | 115 | 14 |
| Example 2 | | |
| Comparative | 221 | 0 |
| Example 3 | | |
| Comparative | 353 | 5 |
| Example 4 | | |

To test the storage stability of the dried noodles, the dried noodles were put into packaging bags, 100 bags for each sample, and were placed under the conditions of room temperature of 20-40° C. and humidity of 45-90%. The indexes of the dried noodles were detected at regular intervals until they deteriorated. The test results are shown in the table 10. The test results show that the shelf life of the dried buckwheat noodles of the example was similar to that of the wheat dried noodles (Comparative Example 4), about 170 days longer than that of the buckwheat dried noodles of Comparative Examples 1 and 2. There was no infestation in the buckwheat dried noodles of the examples during storage, while the infestation rate of buckwheat dried noodles Comparative Examples 1 and 2 was 13-14%. The shelf life of buckwheat dried noodles of Comparative Example 3 was lower than that of the examples. The main reason is that the heat treatment temperature of the grains was high and the treatment time was long. Although endogenous enzymes were effectively inactivated, some of the lipid components were oxidized. They were further oxidized to form off-flavors during storage, which shortened the shelf life. It is shown that the present disclosure can effectively extend the shelf life of buckwheat products by properly treating buckwheat grains, achieving a good effect of killing insect eggs and preventing rancidity.

In addition, the inventors of this present disclosure also conducted tests with other raw materials and conditions listed in this specification with reference to the methods of Examples 1 to 5, and also produced healthy high-content buckwheat dried noodles that have good quality, uniform color without color difference, and have good springiness, hardness, cooking resistance and taste.

What is claimed is:

1. A buckwheat dried noodle, comprising ingredients in parts by weight represented by the following formula: 60-90 parts of whole buckwheat flour, 15-30 parts of high-gluten wheat flour, 5-15 parts of vital wheat gluten, 1-15 parts of resistant starch, 0.5-3 parts of egg white powder, 0.01-0.5 parts of sodium alginate, 0.01-0.15 parts of konjac flour, 0.01-0.15 parts of sodium carbonate, 5-60 U/g of glutamine aminotransferase, 50-400 U/g of hemicellulase, and 50-400 U/g of phytase.

2. The buckwheat dried noodle according to claim 1, wherein the formula of the buckwheat dried noodle further comprises water, the water accounting for 25-32% of a total weight of the formula.

3. A method of preparing the buckwheat dried noodle according to claim 1, comprising steps of:
(1) preparing raw materials according to the formula of the buckwheat dried noodle according to claim 1;
(2) well mixing the whole buckwheat flour, the high-gluten wheat flour, the vital wheat gluten, the resistant starch, the egg white powder, the sodium alginate, the konjac flour, the glutamine transaminase, the hemicellulase and the phytase, and then adding the resultant mixture into a vacuum mixer to obtain a mixed powder;
(3) well mixing the mixed powder with an aqueous solution of sodium carbonate in the vacuum mixer, and starting the vacuum mixer for dough mixing to obtain crumbly dough;
(4) leaving the crumbly dough obtained in the step (3) to rest at a room temperature;
(5) sheeting the crumbly dough obtained in the step (4) to obtain a dough sheet;
(6) cutting the dough sheet obtained in the step (5) to obtain long strips, hanging them on noodle rods, and drying to obtain long strips of buckwheat dried noodles; and
(7) cutting the long strips of buckwheat dried noodles obtained in the step (6) to obtain short strips, and weighing and packaging them to obtain high-content buckwheat dried noodles.

4. The method according to claim 3, wherein the step (1) comprises: providing buckwheat grains, subjecting the buckwheat grains to a disinfestation and sterilization treatment, and then pulverizing them to obtain the whole buckwheat flour.

5. The method according to claim 4, wherein the buckwheat grains include common buckwheat grains and tartary buckwheat grains; the disinfestation and sterilization treatment comprises: washing and tempering the buckwheat grains with ozone water or slightly acidic electrolyzed water to reach a final moisture of 13.0-16.0 wt %, and then treating them with superheated steam, radio frequency heating or microwave; the slightly acidic electrolyzed water has a concentration of available chlorine of 30-70 ppm and a pH value of 5.8-6.2; and the radio frequency heating is controlled to have a resonant frequency of 20-45 MHz, a power of 5-20 kW and a distance between polar plates of 40-120 mm, a thickness of the buckwheat grains on a conveyor belt is 20-50 mm, a treatment time is 180-600 s, and a temperature of the buckwheat grains discharged from a radio-frequency cavity is 50-90° C.

6. The method according to claim 4, wherein the step (1) comprises:
grinding the buckwheat grains obtained after the disinfestation and sterilization treatment, and then subjecting them to ultrafine pulverization or low-temperature vortex pulverization to obtain the whole buckwheat flour; or
grinding the buckwheat grains obtained after the disinfestation and sterilization treatment by using a roller flour mill to obtain buckwheat core powder and buckwheat bran powder, subjecting the buckwheat bran powder to ultrafine pulverization or low-temperature vortex pulverization, and then mixing the resultant buckwheat bran powder with the buckwheat core powder to obtain the whole buckwheat flour; wherein a temperature of the low-temperature vortex pulverization is 10-35° C., and the resultant whole buckwheat flour has a particle size of 80-200 mesh.

7. The method according to claim 3, wherein the step (2) comprises: well mixing the whole buckwheat flour, the high-gluten wheat flour, the vital wheat gluten, the resistant starch, the egg white powder, the sodium alginate, the konjac flour, the aminoamide transaminase, the hemicellulase, and the phytase for 1-6 min and putting the resultant mixture into the vacuum mixer to obtain the mixed powder.

8. The method according to claim 3, wherein the step (3) comprises: mixing in the vacuum mixer at a high mixing speed and then a low mixing speed for 5-15 min under a vacuum degree of −0.08 to −0.04 MPa to obtain the crumbly dough.

9. The method according to claim 3, wherein the resting time of the crumbly dough in the step (4) is 8-20 min.

10. The method according to claim 3, wherein the sheeting in the step (5) is 4-8 passes; and/or, the drying in the step (6) is performed by a ropeway-type drying method for 4-6 h, or the drying in the step (6) is performed by a five-stage drying method comprising: (1) shaping with cold air at a temperature of 25-30° C. and a relative humidity of 85-90%; (2) performing low-speed dehydration at a temperature of 39-45° C. and a relative humidity of 78-85%; (3) performing high-speed temperature dehydration at a temperature of 42-46° C. and a relative humidity of 70-76%; (4) cooling down to temper at a temperature of 34-36° C. and a relative humidity of 56-60%; and (5) performing extended tempering at room temperature.

11. The method according to claim 3, wherein the step (1) comprises:
(1) preparation of whole buckwheat flour:
1) disinfestation and sterilization of buckwheat grains: mixing clean buckwheat grains with a certain amount of slightly acidic electrolyzed water which has a concentration of available chlorine of 60 ppm and a pH value of 6.10, so that final moisture of the buckwheat grains is 15.0 wt %; and placing the treated buckwheat grains on a conveyor belt in a center of a lower plate of a radio frequency processing cavity and reciprocating the conveyor belt for a radio frequency insecticidal treatment for 300 s, wherein a thickness of the buckwheat grains is 30 mm, a working frequency is 45 MHz, a power is 9 Kw, a distance between polar plates is 80 mm, and a temperature of the buckwheat grains discharged from the radio frequency cavity is controlled at 65° C.;
2) milling with roller flour mill: placing the pre-treated buckwheat grains into a roller flour mill for pulverization, and sieving the resultant powder to obtain buckwheat core powder and buckwheat bran powder; and
3) low-temperature vortex pulverization: putting the buckwheat bran powder into a low-temperature vortex pulverizer to pulverize at 20° C. for 12 min to obtain uniform and fine powder of 120-mesh, and then mixing the uniform and fine powder with the buckwheat core flour again to obtain the whole buckwheat flour; and
(2) production of dried noodles:
1) dry powder mixing: weighing and putting 80 kg of the whole buckwheat flour, 15 kg of the high-gluten wheat flour, 10 kg of the vital wheat gluten, 5 kg of the resistant starch, 1.5 kg of the egg white powder, 0.2 kg of the sodium alginate, 0.1 kg of the konjac flour, 25 U/g of the glutamine transaminase, 120 U/g of the hemicellulase, and 200 U/g of the phytase into a vacuum mixer to mix for 4 min to obtain a powdery raw material;
2) mixing: dissolving 0.1 kg of sodium carbonate in 28 kg of water in advance, and adding the resulting solution to the vacuum mixer where dough mixing is conducted at a vacuum degree of −0.06 MPa for 10 min to make the crumbly dough;
3) resting: leaving the dough to rest on a resting belt to age for 15 min;
4) sheeting and cutting: making the rested dough pass through 6 passes of sheeting rollers and then cutting; and
5) drying: using a five-stage drying method comprising: (1) shaping with cold air at a temperature of 28° C. and a relative humidity of 88%; (2) performing low-speed dehydration at a temperature of 42° C. and a relative humidity of 80%; (3) performing high-speed dehydration at a temperature of 44° C. and a relative humidity of 73%; (4) cooling down to temper at a temperature of 35° C. and a relative humidity of 58%; and (5) performing extended tempering at a room temperature for a period of time.
